(19) United States
(12) Patent Application Publication
(10) Pub. No.: US 2008/0203745 A1
(43) Pub. Date: Aug. 28, 2008

(54) Protective covering apparatus for vehicles

(76) Inventor: Melanie Greer Rodriguez, Lompoc, CA (US)

Correspondence Address: LAW OFFICES OF ANDREW Y. SCHROEDER, 1177 Marsh Street, SUITE 100, San Luis Obispo, CA, 93401, US

(21) Appl. No.: 11/713,825

(22) Filed: Feb. 22, 2007

(51) Int. Cl. B60R 19/44; B60J 11/00

(52) U.S. Cl. 293/142

(57) ABSTRACT

An apparatus for protecting the bumper of a vehicle comprising: a planar protective membrane, a retaining pouch, and indicia. The planar protective membrane is comprised of a top side, a bottom side, an anterior end, and a posterior end.

The retaining pouch is a member comprising ballasting weight for the purpose of retaining the apparatus within the vehicle. The indicia is disposed on the top side of the protective membrane. The retaining pouch is affixed to the protective membrane on the anterior end.

### FIELD OF THE INVENTION

The present invention relates to an apparatus for the purpose of preventing scratches, abrasions, and other damage to the exterior of a vehicle.

### BACKGROUND OF THE INVENTION

One of the problems many car owners face is the difficulty in preserving the value of their vehicles. Vehicles may lose their re-sale value for a number of reasons. One reason which may depreciate the value of a vehicle is the poor condition of the paint and exterior of the vehicle. Even minor scratches, dents, abrasions or other “dings” may decrease a vehicle's value by thousands of dollars. Moreover, since many car-owners take great pride in the aesthetic appeal of their vehicles, these imperfections seen on the exterior of their vehicles can become quite annoying to a fastidious car owner.

For those car owners who have a heightened desire to maintain their vehicle's paint and exterior in immaculate condition the only feasible options are quite expensive. Even the most minor scratches, abrasions, or dents can cost over $1000 to restore to its pre-damaged condition. Although there are other economical products which may cosmetically hide these abrasions, scratches and dents, they typically do not perform as well as their claims.

One of the most susceptible areas of a vehicle to scratches, dings, abrasions or dents is the bumper of a vehicle. Many vehicles are equipped with metallic bumpers which are coated with expensive and fragile paint. This poses an expensive problem for those car owners when they attempt to load and un-load heavy and bulky items into the trunk of their vehicles. Oftentimes, the space or “window” through which a person must place an object in order to reach the insides of the trunk is very narrow and unforgiving. This leads to frequent scraping of the bumper along with attendant dings and scratches. For example, if a person were to attempt to extract a folded wheelchair within the trunk of a vehicle, one would find it difficult to lift a heavy wheelchair into the trunk without scraping at least one part of the wheelchair with the bumper.

Another problem frequently encountered are sports enthusiasts who frequently carry large, bulky and heavy items to and from the trunks of their vehicles. Scuba divers, for instance, must lift long, and large tanks in and out of the trunk without scraping the bumper. These heavy items, combined with their cumbersome sizes make the loading very difficult without the scraping of the bumper. And this fact is further complicated when a smaller person with marginal physical abilities attempts to place or extract these objects to and from the trunk of a vehicle.

Therefore, what is clearly needed in the art is an apparatus for the purpose of preserving the paint and integrity of a bumper and nearby regions of the vehicle. This apparatus should be retained quickly, easily, and securely to the trunk of the vehicle. The apparatus should also be composed of a material which is relatively lightweight, soft, yet strong enough to prevent scratches, abrasions, or other “dings” to the bumper of a vehicle. Moreover, the apparatus should provide a person a “landing place” for the object in order to better navigate and orient the object into and away from the vehicle.

### SUMMARY OF THE INVENTION

It is an object of the present invention to provide an apparatus which helps preserve the paint and integrity of the bumper and other regions of a vehicle. The apparatus is used primarily for the purpose of placing and extracting large, cumbersome, and heavy objects which often lead to scratches, abrasions and dents when placed into and extracted from a vehicle.

It is an object of the present invention to provide a durable and flexible material to comprise the membrane with which the bumper is protected. In some preferred embodiments the membrane is comprised of neoprene. In other embodiments, the membrane is comprised of rubber. The flexibility of these materials are both lightweight and flexible for easy use and compact storage.

It is an object of the present invention to provide an apparatus which is lightweight, durable, and easy to use. The present invention is designed to conserve space by being rolled up and placed in a bag with retractable drawstrings.

### BRIEF DESCRIPTION OF THE DRAWING FIGURES

FIG. 1a is a perspective view of a preferred embodiment of the present invention.

FIG. 1b is a side view of a preferred embodiment of the present invention.

FIG. 2 is a perspective view of a preferred embodiment of the present invention.

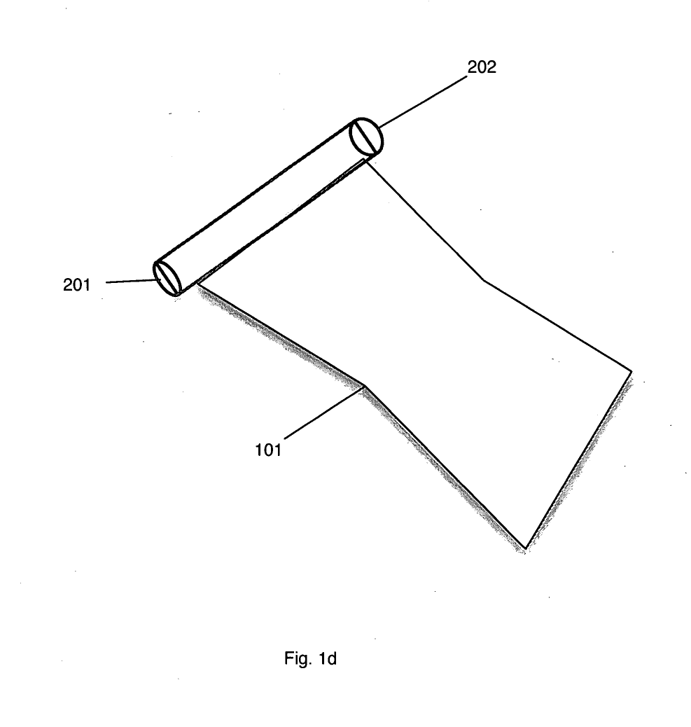

FIG. 3a is a perspective view of a preferred embodiment of the present invention.

FIG. 3b is a perspective view of a preferred embodiment of the present invention.

FIG. 4 is a perspective view of a preferred embodiment of the present invention.

FIG. 5 is a perspective view of a preferred embodiment of the present invention.

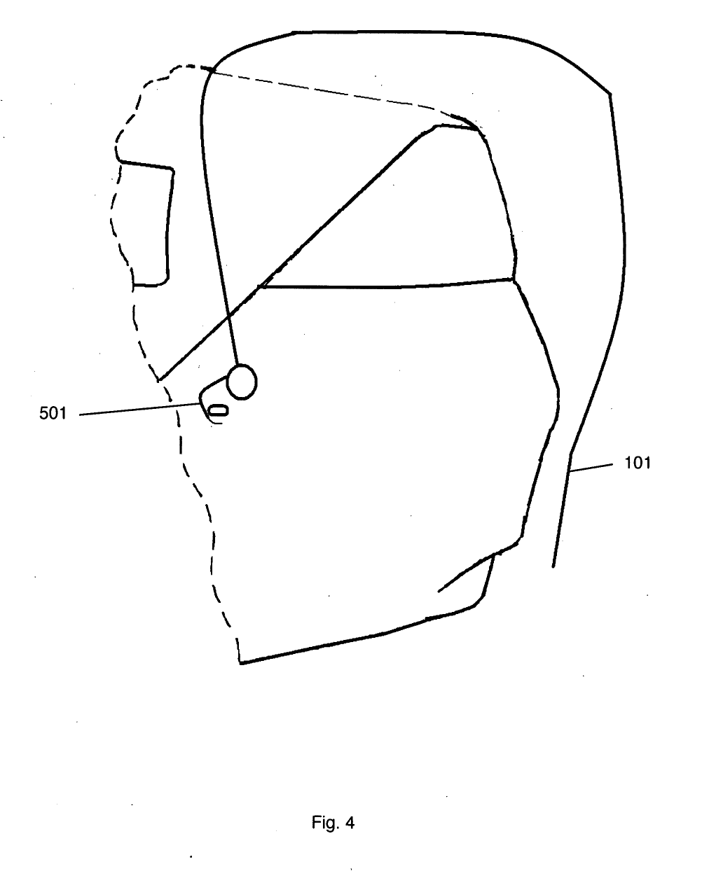

FIG. 6 is a perspective view of a preferred embodiment of the present invention.

FIG. 7 is a perspective view of a preferred embodiment of the present invention.

FIG. 8 is a perspective view of a preferred embodiment of the present invention.

FIG. 9a is a perspective view of a preferred embodiment of the present invention.

FIG. 9b is a side view of a preferred embodiment of the present invention.

FIG. 10 is a side view of a preferred embodiment of the present invention.

### DESCRIPTION OF PREFERRED EMBODIMENTS

According to a preferred embodiment of the present invention, a unique system and apparatus is used to move large objects safely into and out of the trunk of a vehicle without scratching or creating dents on the bumper. Moreover, the present invention provides a safe “landing area” for a person to temporarily set the object on the bumper of a vehicle in order to better navigate the object into the trunk of a car. Moreover, it should be noted that the present invention may also be used for other purposes not mentioned herein. For instance, the present invention may be used with various window openings along the rear of an SUV (Sport Utility Vehicle) or other vehicle. For this reason, the present invention is not meant to be limited to the protection of the bumper of a vehicle. The present invention is described in enabling detail below.

For the purposes of the present invention the term “landing area” shall mean or refer to the area of the apparatus disposed on the bumper to where the person will place the object to be inserted into the vehicle.

For the purposes of the present invention, the word “object” is used to describe the article which is intended to be placed into or extracted from the vehicle. The term “object” should not be confused with the invention itself.

For the purposes of the present invention, the term “pouch” shall describe an apparatus for the purpose of weighing down and providing ballast to the invention.

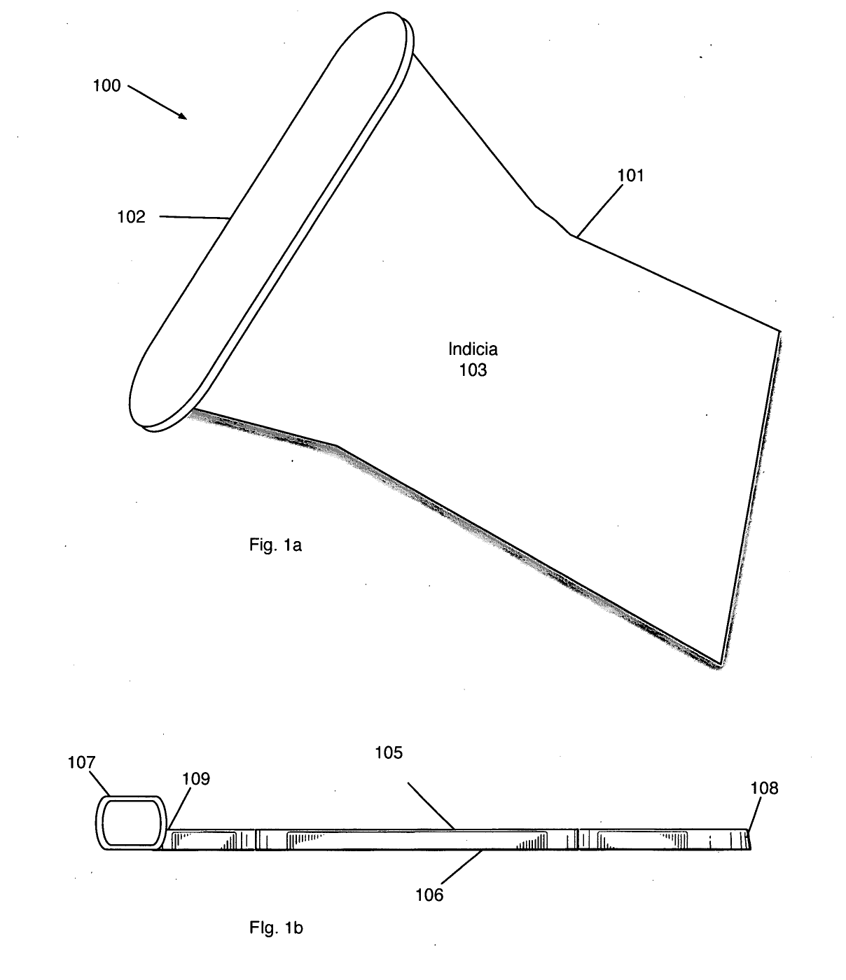

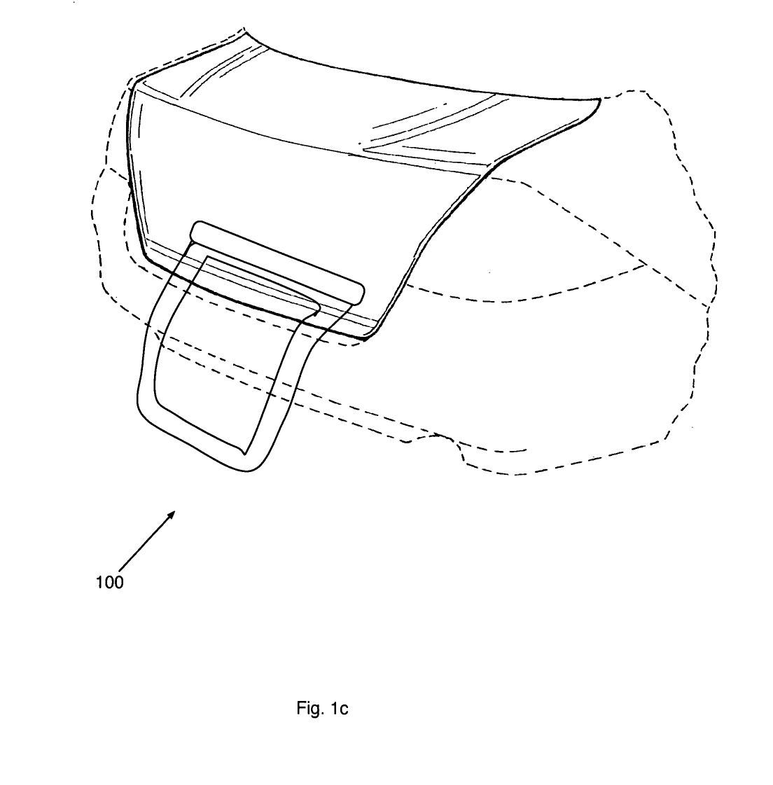

FIG. 1a illustrates one preferred embodiment of the present invention. The bumper protector 100 includes a planar protective membrane 101, a retaining pouch 102, and indicia 103.

The planar protective membrane 101 having a top side 105, a bottom side 106, an anterior end 107, and a posterior end 108. The anterior end is comprised of a leading edge 109. The planar protective membrane is made of a neoprene material in some preferred embodiments. The reason neoprene is used for this invention is because it is durable, strong and waterproof. In other preferred embodiments, the planar protective membrane is comprised of rubber. However, it should be noted that other suitable materials may also be used with the present invention. For this reason, the scope of the present invention is not limited to the use of neoprene or rubber.

The retaining pouch 102 is a member comprising ballasting weight for the purpose of retaining the apparatus within the vehicle. The purpose of the retaining pouch is to secure the planar protective membrane to the vehicle. The retaining pouch acts as an anchor for the planar protective membrane. In some preferred embodiments the retaining pouch is comprised of a ballasting weight such as sand, shot, or similar material which is wrapped in a fabric or other suitable material. In some other preferred embodiments, the ballasting weight may be a single unitary member, such as a metal bar with enough weight to properly anchor the invention within the vehicle.

The retaining pouch is sealed in some preferred embodiments by simply sewing the fabric or suitably material closed in order to retain the ballasting element. The retaining pouch is affixed to the planar protective membrane through many different means. Exemplary means include hooks and loops, adhesives, sewing, magnets, snaps, buttons, etc.

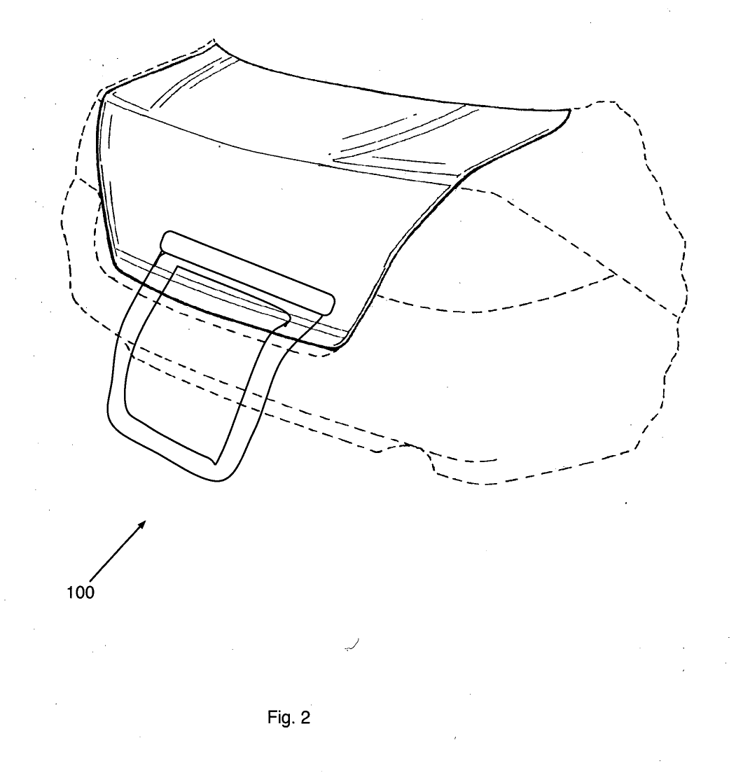

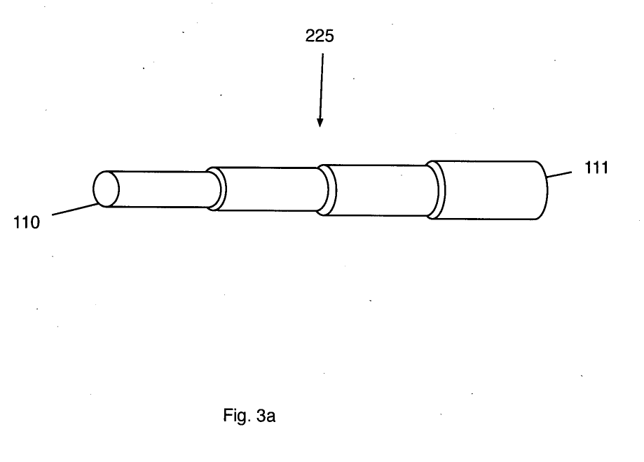

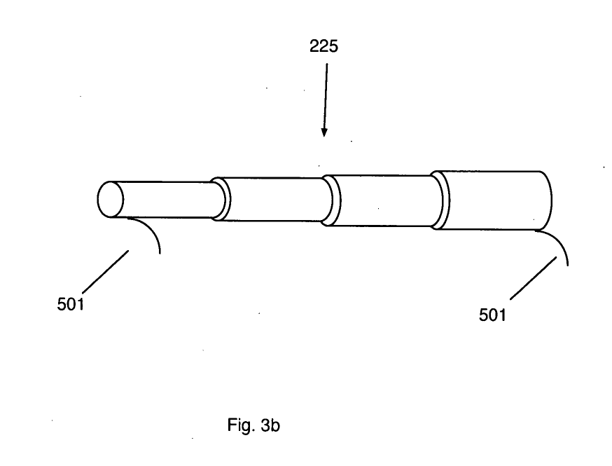

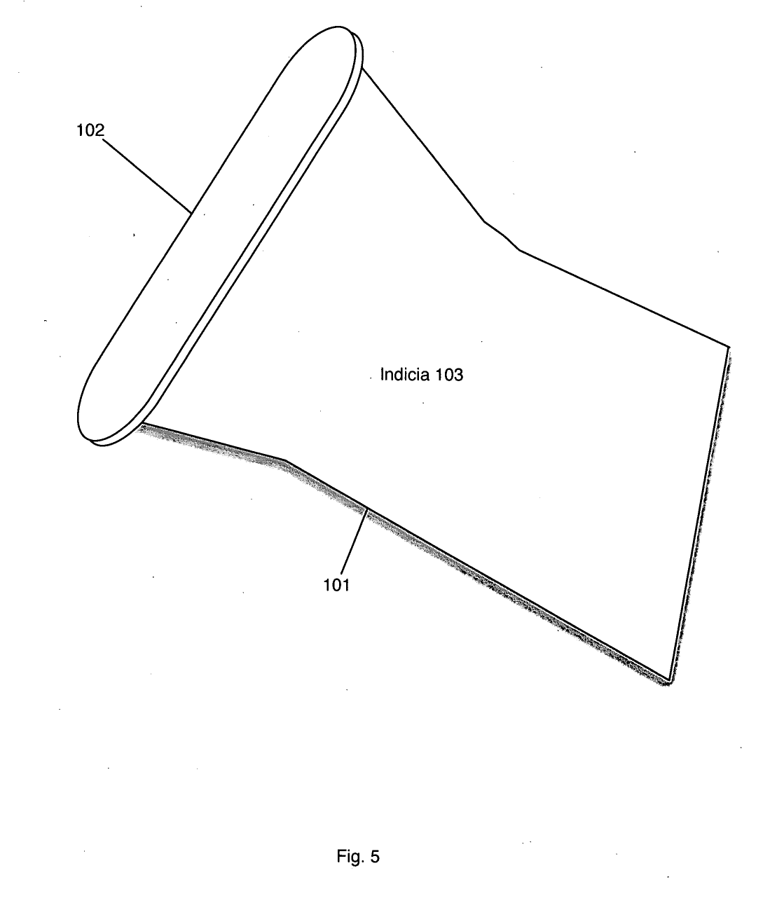

In other preferred embodiments, the retaining pouch is replaced or augmented with a retaining member 225 as shown in FIG. 3a. In some preferred embodiments, the retaining member is telescopic. The reason for incorporating a telescopic member is in order to make the present invention more compact and easy to use. The telescopic version is comprised of a plurality of similarly shaped cylinders which are disposed within each other and are slideably affixed with each other. In other preferred embodiments, the retaining member further comprises hooks 501 as shown in FIG. 3b. In FIG. 4, the hooks are used to anchor the invention within the trunk of a vehicle by wrapping around a fixed object. In some preferred embodiments, the retaining member is directly affixed with the planar protective membrane as shown in FIG. 6.

Indicia 103 is disposed on top of the planar protective membrane on the top side. Indicia may be used for marketing purposes, design logos, trademarks, and similar information and designs. Indicia will be affixed to the planar protective membrane depending upon a variety of factors. Such factors include the type of material used for the planar membrane, the type of colors or illustrations to be used for the indicia, and the means of applying the indicia to the planar protective membrane. Various means include wax, stitching, cloth patches, paint, etc. The present invention is not limiting in scope of the type of indicia to be used with the present invention.

In some preferred embodiments, the distal edge of the anterior end is folded over and disposed upon the protective membrane thereby forming a hollow cavity 200. The hollow cavity is comprised of a first opening and a second opening. The distal edge of the anterior end is affixed to the protective membrane. Furthermore, the distal edge of the anterior end is affixed to the protective membrane by sewing the distal edge of the anterior end to the protective membrane.

In some preferred embodiments comprising a hollow cavity, a ballasting element(s) 203 is also incorporated. In contrast to the retaining pouch, the ballasting element is incorporated without a completely separate pouch or apparatus as in other embodiments. The ballasting element is disposed within the hollow cavity. For the purposes of the present invention, the term “ballasting element” shall mean any material or element which adds weight in order to retain the present invention or to anchor the present invention to the vehicle. Examples of ballasting elements include sand, shot, metal bars, etc. In one preferred embodiment, the ballasting element is comprised of sand. The sand is simply poured into the hollow cavity and is sewn at both sides in order to retain the ballasting element.

In other preferred embodiments the retaining member is disposed within the hollow cavity longitudinally. The retaining member can affix to the vehicle either by means of a hook on the retaining member to fasten to a lip of the trunk of a vehicle or other salient immovable articles within the trunk of the vehicle to which the present invention may be securably fastened or tethered.

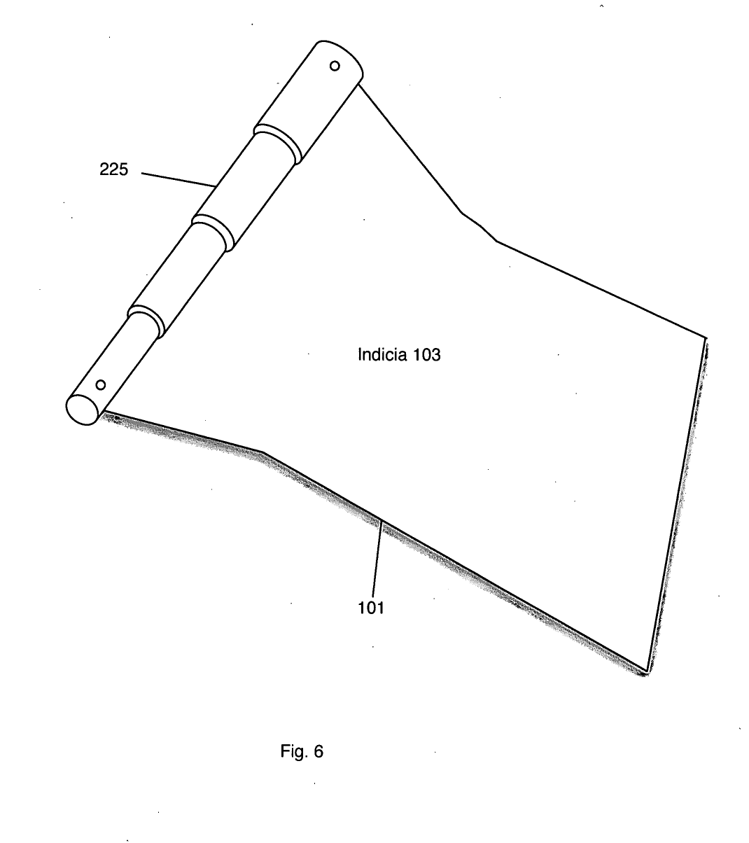

FIG. 7 illustrates that in some preferred embodiments, the present invention may further comprise bungee cords 400. Bungee cords comprise a first hook 401 and a second hook 402. The first hook is secured to the membrane with an orifice 150 within the planar protective membrane. And the second hook is secured to a fixed object or projection within the vehicle.

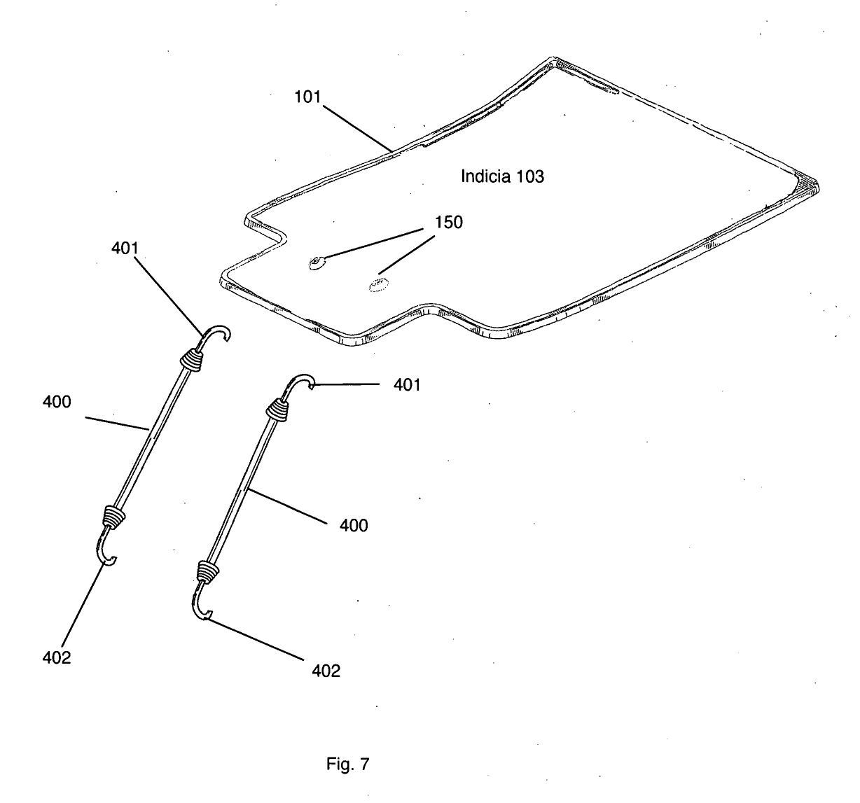

FIG. 8 shows that in some preferred embodiments the present invention may further comprise a retaining bag 300 for the purpose of stowing away the present invention. This retaining bag may comprise at least one drawstring 301 for the purpose of closing or narrowing the orifice with which the present invention is placed.

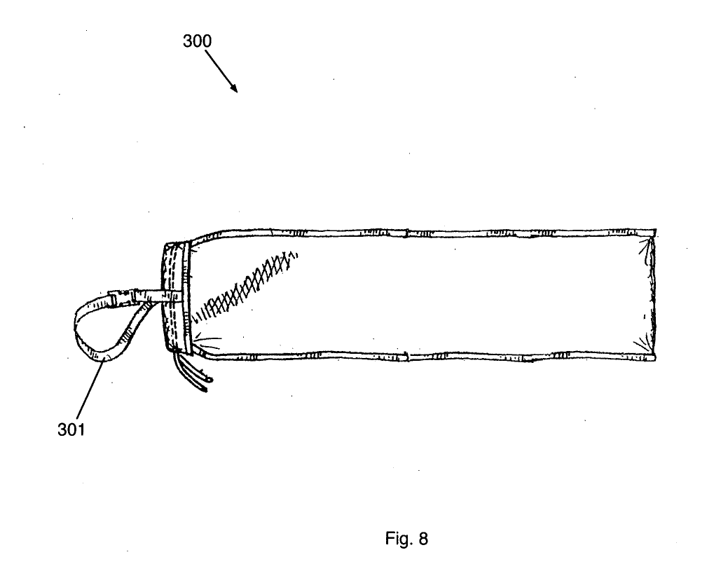

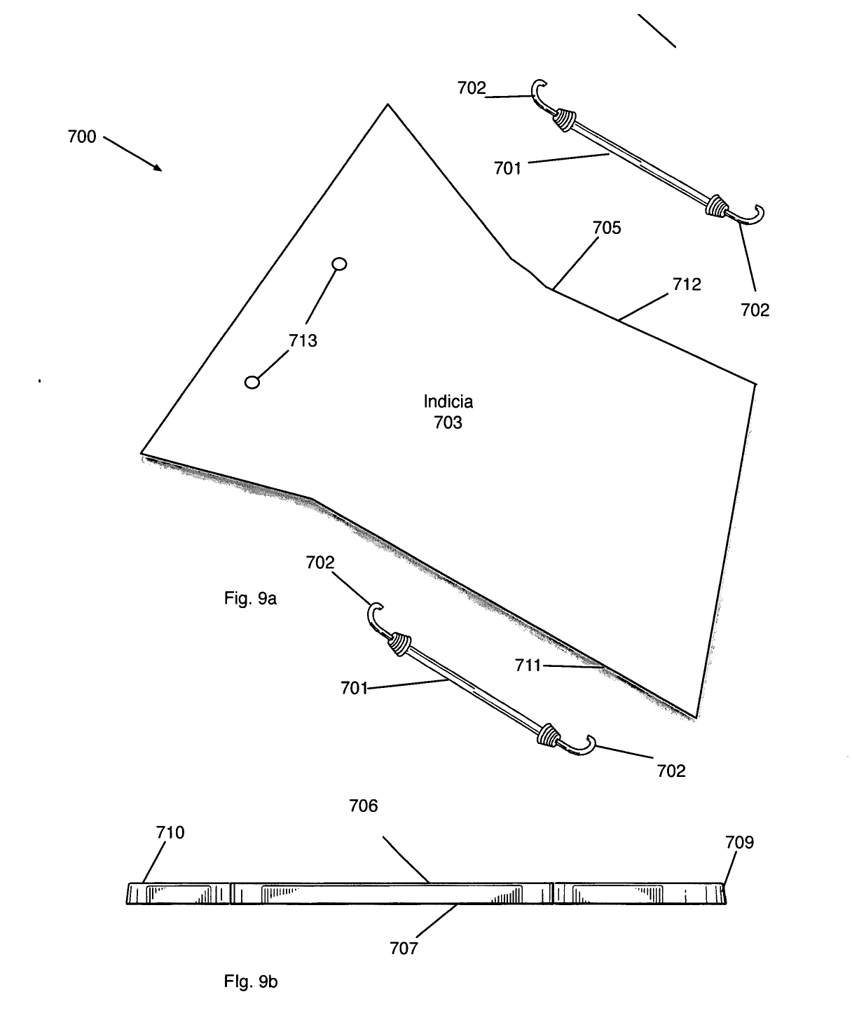

FIGS. 9a and 9b illustrate another preferred embodiment of the present invention. Bumper protector 700 comprises at least one cord 701, at least one hook 702, one membrane 705 and indicia 703. The membrane has a first side 706, a second side 707, a front end 709, a rear end 710, lateral sides 711, 712, and at least one orifice 713. The cord having a first distal end and a second distal end. The cord is affixed to the membrane at the first distal end and retains the membrane with the vehicle at the second distal end. The first distal end of the cord is affixed through use of the orifice of the membrane. At least one hook is affixed to either the first distal end or the second distal end or both distal ends. The indicia is disposed on the first side of the membrane.

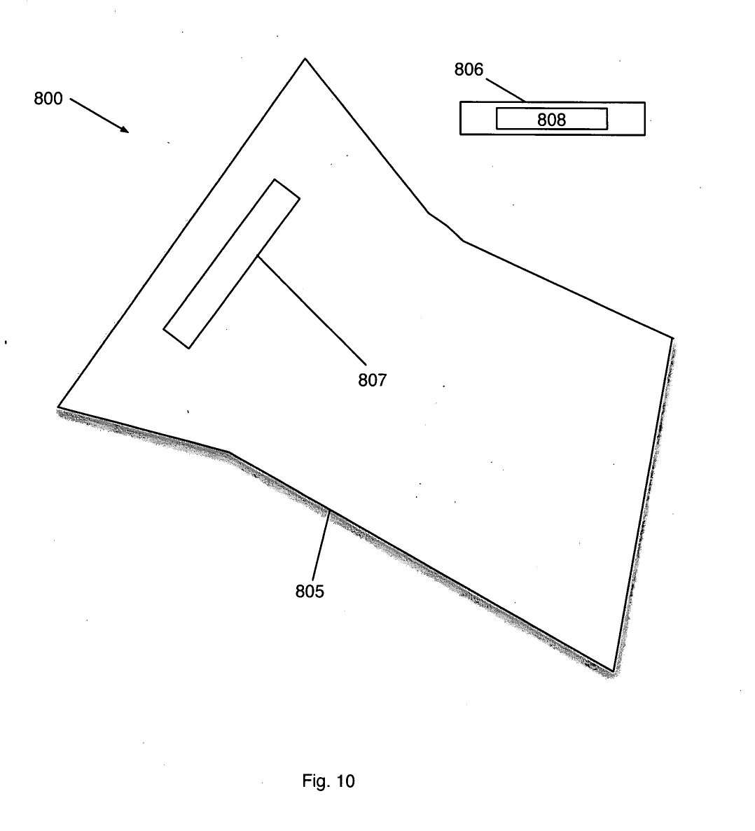

FIG. 10 illustrates another preferred embodiment where an apparatus 800 for use in protecting the exterior of a vehicle comprises: a protective sheet 805, a layer of hooks material 806 and a layer of loops material 807, and an adhesive strip 808. Either the layer of hooks material or the layer of loops material is disposed on the protective sheet. And either the hooks material or the layer of loops material is affixed to the vehicle. For instance, the layer of loops material may be affixed to the inner panel of the trunk of a vehicle. The adhesive strip is affixed to the layer affixed with the vehicle. The apparatus is thereby anchored to the vehicle by connecting one strip of loops material to the other strip of hooks material.

Those skilled in the art will appreciate numerous variations in the present system, configuration and operation that are within the scope of the invention. Those skilled in the art will also appreciate how the principles illustrated in these preferred embodiments can be used in other examples of the invention. A particular reference number in one figure refers to the same element in all of the other figures.

Moreover, It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. An apparatus for protecting the bumper of a vehicle comprising:
a planar protective membrane, a retaining pouch, and indicia;
the planar protective membrane having a top side, a bottom side, an anterior end, and a posterior end;
the retaining pouch is a member comprising ballasting weight for the purpose of retaining the apparatus within the vehicle;
the indicia is disposed on the top side of the protective membrane;
the retaining pouch is affixed to the protective membrane on the anterior end.

2. The apparatus for protecting the bumper of a vehicle of claim 1 wherein the planar protective membrane is comprised of rubber.

3. The apparatus for protecting the bumper of a vehicle of claim 1 wherein the planar protective membrane is comprised of neoprene.

4. The apparatus for protecting the bumper of a vehicle of claim 1 wherein the distal edge of the anterior end is folded over and disposed upon the protective membrane thereby forming a hollow cavity;
the distal edge of the anterior end is affixed to the protective membrane.

5. The apparatus for protecting the bumper of a vehicle of claim 4 wherein the distal edge of the anterior end of the planar protective member is affixed to the protective membrane by sewing the distal edge of the anterior end to the protective membrane at a pre-determined point.

6. The apparatus for protecting the bumper of a vehicle of claim 5 further comprising a ballasting element; the ballasting element is disposed within the hollow cavity.

7. The apparatus for protecting the bumper of a vehicle of claim 6 wherein the ballasting element is retained within the hollow cavity by sewing the first opening and the second opening of the hollow cavity together thereby retaining the ballasting element.

8. The apparatus for protecting the bumper of a vehicle of claim 4 wherein the retaining member is disposed longitudinally within the hollow cavity.

9. The apparatus for protecting the bumper of a vehicle of claim 1 wherein the retaining member is telescoping.

10. The apparatus for protecting the bumper of a vehicle of claim 1 further comprising a bag for retaining the membrane and retaining member; the bag is comprised of a flexible material, the bag comprising a flexible orifice, drawstrings, and a flexible material sheet.

10. An apparatus for protecting the bumper of a vehicle comprising a membrane, at least one cord, at least one hook, and indicia;
the membrane has a first side, a second side, a front end, lateral ends, and a rear end, and at least one orifice;
the cord having a first distal end and a second distal end; the cord is affixed to the membrane at the first distal end and retains the membrane with the vehicle at the second distal end;
the first distal end of the cord is affixed through use of the orifice of the membrane;
at least one hook is affixed to either the first distal end or the second distal end or both distal ends;
the indicia is disposed on the first side of the membrane.

11. The apparatus for protecting the bumper of a vehicle of claim 10 wherein the cord is a bungee cord.

12. The apparatus for protecting the bumper of a vehicle of claim 10 having 2 hooks, each hook is disposed on each distal end of the cord.

13. The apparatus of claim 10 wherein the membrane is comprised of neoprene.

14. The apparatus for protecting the bumper of a vehicle wherein the planar sheet is comprised of neoprene.

15. The apparatus for protecting the bumper of a vehicle wherein the retaining members are curved to form a hook.

16. The apparatus of claim 10 wherein the membrane is comprised of rubber.

17. The apparatus of claim 10 wherein the indicia is sewed into the membrane.

18. An apparatus for use in protecting the exterior of a vehicle comprising:
a protective sheet, a layer of hooks material and a layer of loops material, and an adhesive strip;
either the layer of hooks material or the layer of loops material is disposed on the protective sheet; either the hooks material or the layer of loops material is affixed to the vehicle; the adhesive strip is affixed to the layer affixed with the vehicle.

19. The apparatus of claim 18 wherein the protective sheet is comprised of neoprene.

20. The apparatus of claim 19 wherein the protective sheet is comprised of rubber.
